(19) United States
(12) Patent Application Publication
(10) Pub. No.: US 2003/0236835 A1
(43) Pub. Date: Dec. 25, 2003

(54) Network communication system and apparatus

(76) Inventors: Ronald M. Levi, Calabasas, CA (US); Richard Oliver, Ladysmith (CA)

Correspondence Address: BRULL PICCIONELLI SARNO BRAUN & VRADENBURGH, Suite 2350, 1925 Century Park East, Los Angeles, CA, 90067, US

(21) Appl. No.: 10/177,463

(22) Filed: Jun. 19, 2002

(51) Int. Cl. G06F 15/16; G09G 5/00

(52) U.S. Cl. 709/204; 345/753; 709/234; 345/758

(57) ABSTRACT

The present invention is directed to a network communication system and apparatus for use by multiple users, wherein a single user can concurrently, or substantially simultaneously, utilize multiple communication modalities and communicate with different users without regard for the transmission capabilities of any particular user. The communication system comprises a communication manager, a plurality of communication mediums or modalities, at least one storage database, and an administrative manager, wherein the plurality of communication mediums are integrated for substantially simultaneous use by a single user in a multi-user environment.

### FIELD OF THE INVENTION

The present invention is directed to a network communication system and apparatus for use by multiple users, wherein a single user can simultaneously access multiple transmission means. In particular, a communication system having a plurality of transmissions modalities that allow a user to substantially simultaneously communicate via multiple transmission modalities without regard for the transmission capabilities of any particular user.

### BACKGROUND OF THE INVENTION

Communication systems have allowed people in different cities, towns and even countries to effectively communicate with each other. In addition to the development of commerce, the ability to effectively communicate anywhere in the world has allowed for the exchange of ideas and cultures.

Initially, communication beyond an individual's home was accomplished via writing. Eventually, the telephone was developed, wherein early telephonic communication was limited to single person to person communication. However, techniques were developed that allowed for teleconferencing, wherein multiple users could talk in the same conversation as if all of the users resided in the same location. One disadvantage with telephonic communication, however, is that an individual must know how to connect with another individual via a telephone number. Of course, individuals could simply randomly dial telephone numbers, but most likely, would encounter displeased recipients of the random and unsolicited calls. Another disadvantage is that users do not know who else is available for communication exchange and, even if known, would be required to disconnect from one communication to engage in another.

The advent of wide area networks, such as the Internet or World Wide Web (“WWW”), adds to the communication systems available to individuals. Indeed, new communication modalities have emerged on wide area networks. Some of the new modalities include chat rooms, electronic mail, video mail and remote conferencing. Some of these modalities, for example, chat rooms, allow users to join in a conversation at will, and thus, eliminates the initial requirement that users must have codes, that is, telephone numbers, to initially reach other users. Of course, some modalities, such as, electronic mail still require a code, such as an address. However, the public type communication modality allows users to meet new individuals.

Although the Internet has introduced new communication modalities, communication among users is dependent, in part, upon the transmission abilities of each individual, that is, the rate of transmission that the user's equipment is capable of processing. Unfortunately, no single transmission capability exists on the Internet. Rather, transmission ability is dependent upon equipment. The more expensive equipment generally provides for increased transmission ability, both in terms of speed and quantity. Thus, users do not uniformly access the Internet, In light of the varying transmission capabilities, at least one problem encountered by public network communication systems is the identification of an appropriate transmission speed. Indeed, providers of public communication modalities, for example, remote conferencing, tend to prefer or adapt lower, if not the lowest, transmission capability to allow the greatest number of users to access the system and to minimize costs. Thus, users having greater transmission capabilities do not benefit from their greater capacity.

Further, current systems only allow users the ability to access one modality at a time. In this manner, costs are minimized both in terms of software and hardware. Thus, other than in a chat room, a user cannot have multiple conversations or communication exchanges with multiple users via multiple types of modalities. To access another type of communication modality, a user must exit from the one currently being used, for example, remote conferencing, to access a new modality, for example, a chat room or an electronic mail system. Further still, none of the current systems are compatible with third party networks which provide communication services not provided by the public network communication systems, such as wireless applications.

Additionally, the current systems only allow for one type of communication exchange at a time. In many instances, a user is limited to textual communication exchanges. Audio communication has typically been limited to remote conferencing or video mail. However, in most current modalities, only one type of exchange is available at a time.

A need in the industry exists for a communication system that allows multiple peer to peer communications with multiple users utilizing multiple communication modalities that can be accessed substantially simultaneously. A further need exists for a communication system that is configured to concurrently accommodate varying types of transmission capabilities among users. Further still, a need exists for a communication system that allows users to control various aspects of the system, thereby controlling the quality of communication, prioritization of communications and access by other users to a given modality utilized by a particular user.

### BRIEF DESCRIPTIONS OF THE DRAWINGS

The detailed description of embodiments of the invention will be made with reference to the accompanying drawings, wherein like numerals designate corresponding parts in the figures.

FIG. 1 is a communication application system in accordance with preferred embodiments of the invention as integrated into a network system.

FIG. 2 is an exemplary interface illustrating the function directory and sets of control operators for the communication manager in accordance the preferred embodiment of FIG. 1.

FIG. 3 is a pull down menu for chat room control operators, including an opened “Room Mode’ operator window, in accordance with a preferred embodiment of the invention

FIG. 4 is a pull down menu for preference control operators, including an opened “general” operator window, in accordance with a preferred embodiment of the invention.

FIG. 5 is a plurality of communication mediums in use by a single user in accordance with the preferred embodiment of FIG. 1.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### SUMMARY OF THE DISCLOSURE

The present invention is directed to a network communication system and apparatus for use by multiple users, wherein a single user can concurrently, or substantially simultaneously, utilize multiple communication modalities and communicate with different users without regard for the transmission capabilities of any particular user. The communication system comprises a communication manager, a plurality of communication mediums or modalities, at least one storage database, and an administrative manager coupled together in electronic communication with each other and the provider computer.

The communication manager is a software program that integrates the use of the various communication mediums, including identifying transmission rate capabilities between communication users. The communication manager comprises a function directory, and at least one set of control operators, wherein each set of control operators are appurtenant to a particular function.

The function directory is an option menu comprising utility functions and communication mode functions. In preferred embodiments, the utility functions are activity management functions, such as, creating or editing parameters or lists for use in the functions, which assist in defining parameters or other types of information that is utilized throughout the communication system. Information added or altered via the utility functions is stored in the database for access by the communication manager.

The communication mode functions identify the communication modalities currently available in the communication system. In preferred embodiments of the present invention a plurality of these communication modalities are simultaneously accessible to users in one application, wherein the access to any communication modality does not require the closing of another communication modality. Further, in preferred embodiments, users define control parameters for the communication modalities, wherein the control parameters affect the operation of the communication modalities.

A feature of preferred embodiments is that data transmissions can be modified such that users with varying transmission rates can be accommodated. An advantage to this feature is that a wider audience of users can participate in the system without incurring the cost of expensive equipment or wasting time modifying existing hardware. A further advantage is that users having higher transmission capabilities receive the benefit of their higher transmission capabilities without limiting their ability to communicate with all users.

A further feature of preferred embodiments is that users can choose the rate of audio data transmissions that they desire to receive. An advantage to this feature is that users can better control usage of their resources and the quality of received transmission.

A still further feature of preferred embodiments is that multiple modalities for communication are accessible by the users substantially simultaneously. An advantage to this feature is that a user can communicate with multiple users in a plurality of communication formats substantially simultaneously. Another advantage to this feature is that a user can communicate with multiple parties on separate communication modalities without any party being aware of the contents of the other communications.

Another feature of preferred embodiments is that the communication system is scalable via software control for operations on both the server side and client side. An advantage to this feature is that the system can manage large fluctuations in user use without costly hardware. A further advantage is that down time is avoided due to an overloaded system as the system is capable of managing the influx of user traffic in real time. A still further advantage to this feature is that the system allows for scalability with respect to user preferences such that more features can be added as needed.

A further feature of preferred embodiments is a buffer mechanism for storing incoming transmissions temporarily. An advantage to this feature is that the system automatically controls the broadcasting or re-transmission of incoming audio communications such that the recipient is not receiving multiple audio transmissions simultaneously.

A still further feature of preferred embodiments is a user controlled buffer mechanism for storing audio transmissions. An advantage to this feature is that users can store audio data streams for later review and thereby prioritize receipt of communications with others.

Another feature of preferred embodiments is that users can control the receipt of information from other users. An advantage to this feature is that a user can eliminate abusive communications without reliance upon a system manager to act, and further, can create private communications with other users.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### DETAILED DESCRIPTION OF PREFERRED EMBODIMENTS

Preferred embodiments of the instant invention operate on a network, such as, for example, the Internet or World Wide Web (“WWW”), or any other type of network system, including, an internet or an intranet.

Hardware Environment:

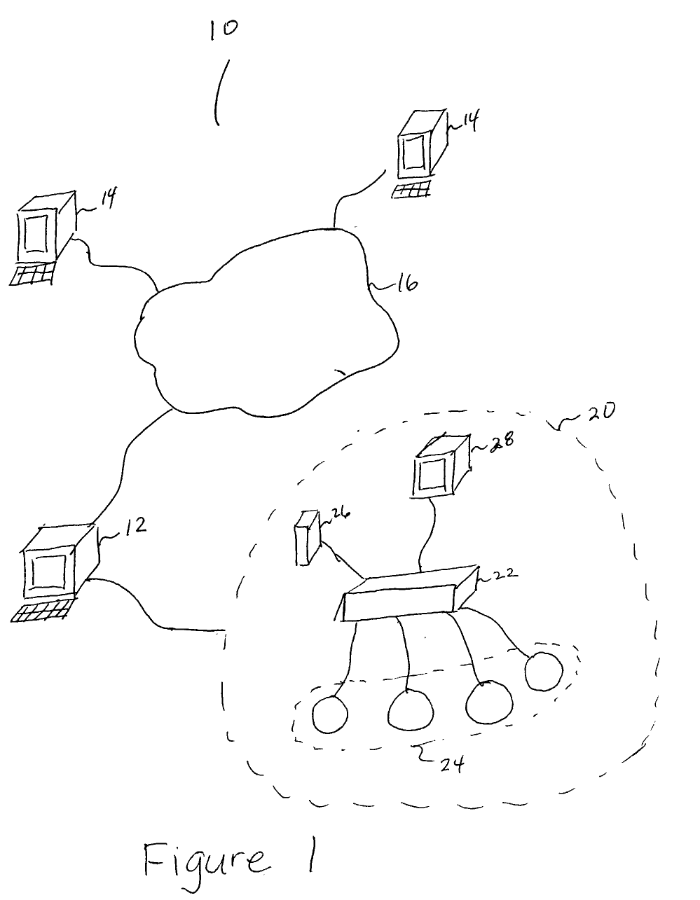

Preferred embodiments of the instant invention operate in accordance with a plurality of networked computers, such as, for example, a user or subscriber computer and a provider computer which are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, and a user computer 14, wherein the provider computer 12 and the user computer 14 are in electronic communication with each other via a communication link 16.

In some preferred embodiments, the network system 10 includes a plurality of either the provider computer 12, the user computer 14 or any combination thereof. The provider computer 12, or server, may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media (for example, but not limited to, floppy disks, hard disks, random access memory RAM, CD-ROM), to provide content for communication to a user computer 14. The provider computer 12 may comprise, for example, but not limited to, a personal computer, a mainframe computer, network computer, portable computer, personal digital assistant (such as, a 3Com Palm Pilot), or the like. The provider computer 12 may include one or more internal data storage devices (not shown) for storing content for communication to a user computer 14. Alternatively, or in addition, the provider computer 12 may be coupled to an external data storage device, computer or other means (not shown) from which the provider computer 12 may obtain content for communication to the subscriber computer 14. In one embodiment, the external device may comprise a further network device coupled in the network 16. The provider computer 12 is controlled by suitable software to provide the requested content to the requesting user computer 14, provided that various criteria are met.

In a preferred wide area network environment, such as the Internet environment, the provider computer 12 is controlled by suitable software to respond to a valid request for content by providing (or downloading) data to the user computer 14 from which the request was made. It will be understood by those skilled in the art that this process involves communications through suitable servers, routers and other components, as is dictated by the particular network environment.

The provider computer 12 operates with a persistent storage means (not shown), for example, one or more of the fixed and/or removable data storage devices and/or data communications devices connected to the computer. The communication link 16 may include a public network, such as the Internet, a local area network, or any other suitable communications connection, hardwired, wireless, or a hybrid thereof The user computer 14 may comprise any suitable network device capable of communicating with other network devices in the network system. In preferred embodiments, each user computer comprises a programmable processor capable of operating in accordance with programs stored on one or more computer readable media (for example, but not limited to floppy disc, hard disc, computer network, random access memory (RAM), CD Rom, or the like), a display device for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device (for example, but not limited to, a keyboard, mouse, microphone, or the like). In one preferred embodiment, at least one subscriber computer comprises a personal computer system having a CRT display, a keyboard and a mouse user-input device.

The user computer 14 is controlled by suitable software, including network communication and browser software to allow a user to request, receive and display information (or content) from or through a provider computer 12 on the network system 10. The user computer 14 operates in accordance with programs stored on a readable medium, including, but not limited to, floppy disks, hard disks, RAM and CD-ROM. The user computer 14 is any means capable of communicating with the provider computer 12, including, but not limited, to personal computers, kiosks and ATM-type machines. The user computer 14 accesses the provider computer 12 via the wide area network or through some other remote access, such as, for example, by telephone, facsimile, personal digital assistant, pulse code system, web TV, or any other device or method that communicates alpha numeric data with a server.

General Description of Preferred Embodiments:

Embodiments of the present invention are directed to a method, apparatus and system for a communication system and apparatus. More specifically, embodiments of the present invention are directed to a communication system that is configured to allow users to concurrently, or substantially simultaneously, utilize multiple communication modalities for the transmission of data, including, but not limited to, text, audio, graphics, and multimedia.

With reference again to FIG. 1, the communication system 20 operates on a network having a provider computer 12 and at least one client or user computer 14. The communication system 20 comprises a communication manager 22, a plurality of communication mediums or modalities 24, at least one storage database 26, and an administrative manager 28 coupled together in electronic communication with each other and the provider computer 12.

The communication manager 22 is a software program that resides on the provider computer 12 or separate server coupled to the provider computer 12. The communication manager 22 includes a series of interface pages. The communication manager 22 integrates the use of the various communication mediums, and via a transmission rate converter identifies transmission rate capabilities between communication users. If a transmitted message is not transmitted at a rate compatible with the receiving machine, the communication manager 22, via the transmission rate converter, converts the incoming transmission to the rate capable of being accepted by the receiving machine. In preferred embodiments, the transmission rate converter is a processor and conversion of transmission rates is accomplished by well established protocols, including, but not limited to, G711 and G723.1, although any means capable of converting the rates is suitable. In preferred embodiments, the conversion of transmission rates to create compatibility between users is performed automatically. As the conversion is not dependent upon types of user computers or any particular transmission rate, compatibility between all users is accomplished. Further, user computers having higher transmission rate compatibilities are not hindered by those having lower transmission rates, thereby allowing each user to maximize use of their resources and benefit from greater capabilities of their equipment.

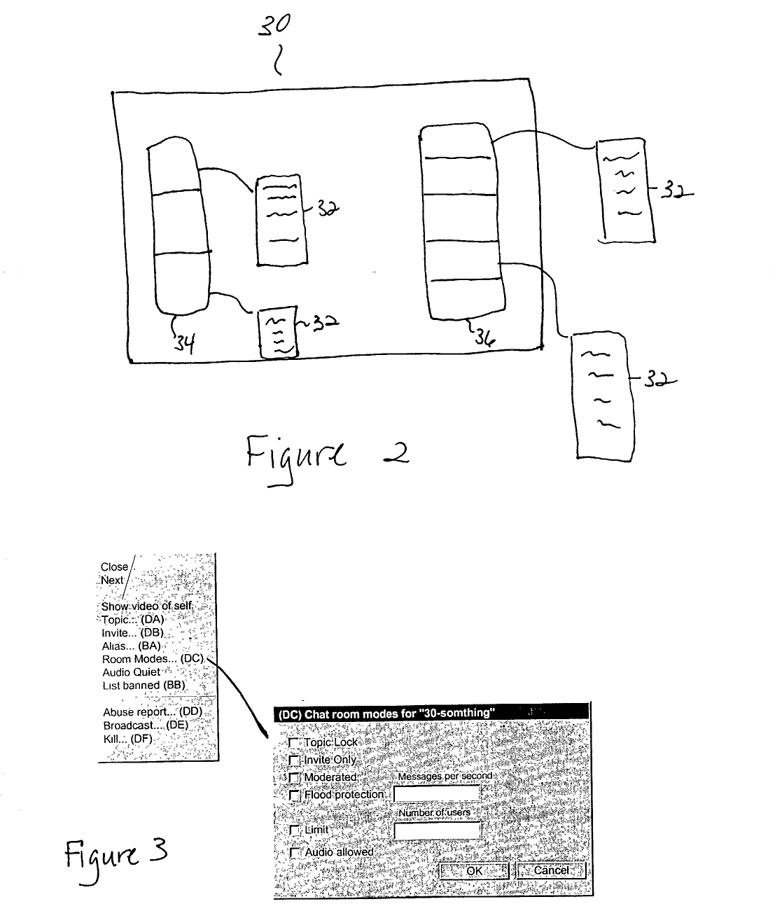

The communication manager 22 comprises a function directory 30, and at least one set of control operators 32, wherein each set of control operators are appurtenant to a particular function. It is to be understood that individual control operators might be used in connection with other functions, and further, it is not intended that predefined sets of controls are necessarily restricted to use with only one communication medium, but if appropriate, can also be used with other communication mediums. An interface page of the communication manager 22 presents the function directory 30 and sets of control operators 32 to allow user and system administrative access. With reference to FIG. 2, the function directory 30 displays the available communication modalities via a series of icons. In other preferred embodiments, the available communication modalities can be displayed via a pull-down menu or by any other suitable means.

The function directory 30 is an option menu comprising utility functions 34 and communication mode functions 36. As stated above, in one preferred embodiment, the function directory 30 is a series of icons, wherein each icon identifies a particular function. Upon clicking on an icon, the function is opened and becomes accessible to the user. Additionally, the set of control operators 32 for each function can be accessed via a pull-down menu. In one preferred embodiment, the list of the set of control operators for a specific communication mode function 36 is accessed, in part, by right clicking on the communication mode function icon. In this manner, the user, if desired, can preset control operators for the various functions prior to opening the function. However, as discussed below, the control operators are also accessible upon the opening of the function.

In preferred embodiments, the utility functions 34 are activity management functions, such as creating or editing parameters or lists for use in the functions The utility functions 34 assist in defining parameters or other types of information that is utilized throughout the communication system. For example, utility functions assist in obtaining various types of information including, but not limited to, information pertaining to login information, personal user profiles, system preferences, and a ‘friend’ list. Information added or altered via the utility functions is stored in the database 26 for access by the communication manager 22, wherein the storage database 26 is any type of storage medium, internal to the communication system, or separately coupled to the communication system, or any combination thereof The communication mode functions 36 identify the communication modalities currently available in the communication system 20. If a communication modality is no longer available, or a new one becomes available, the identification of the modality is added or deleted, thereby adding or removing access to the function by the user. In one preferred embodiment, the communication mode functions 36, include, but are not limited to, electronic mail (“e-mail”), video mail (“v-mail”), chat, video conferencing, and data transfer capabilities. It is to be understood that the above-identified communication modalities operate substantially in a manner consistent with the currently available systems, as recognized by those reasonably skilled in the art. Thus, a full explanation of each of these operations is not set forth herein. However, as discussed below, preferred embodiments of the present invention bundle these communication modalities into one application and further allow the user to define control parameters for the communication modalities which affect the operation of the communication modalities.

Each of the communication and utility functions are associated with a set of control operators 32 that define the parameters of the use of the communication modality or utility function. In preferred embodiments, the setting of the control operators are defined by both the communication system 20 and the user. For example, the system usually creates default settings for a variety of function settings, including, but not limited to, video transmissions, display format, and audio recording and playback.

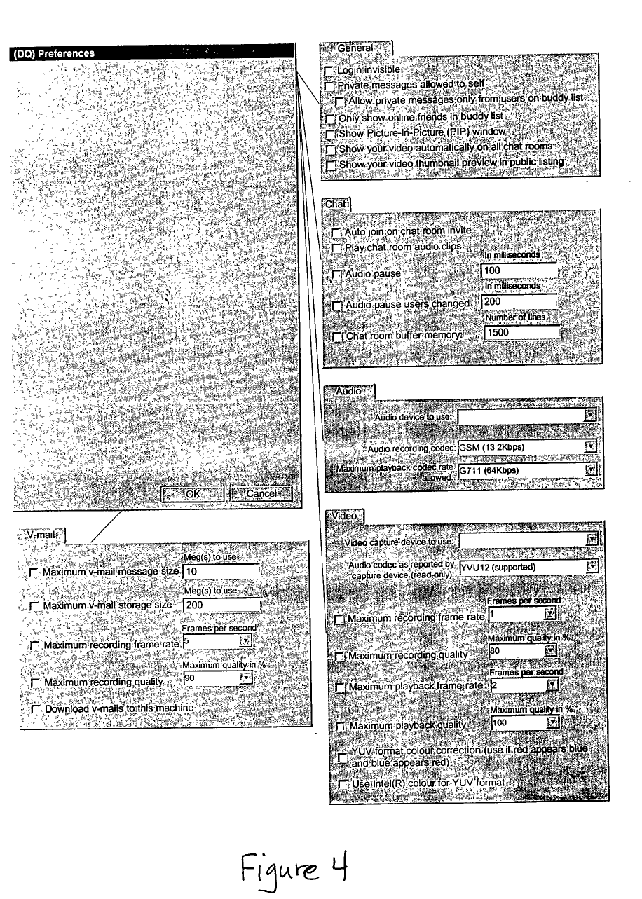

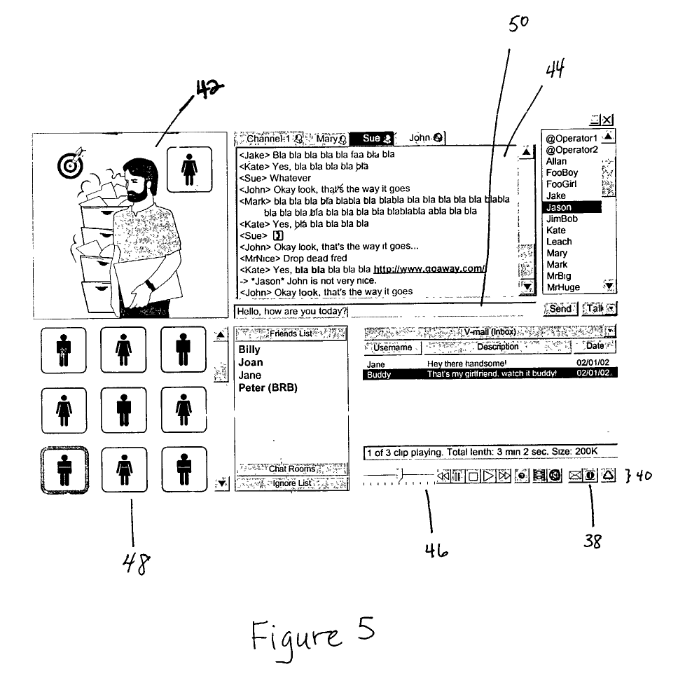

In preferred embodiments, some of the control operators associated with various functions can be preset, or changed, via a pull-down menu on the function directory 30, as discussed above. When pulled down, the menu lists the various control operators for the particular function. By clicking on the particular control parameter, the user is transmitted to a web page or a window, wherein the user can define the control operations. For example, and with reference to FIG. 3, control operators for a private chat room are listed in a pull-down menu. Accessing one of the operators, for example, Room Mode, transmits the user to a window, wherein the user can define the parameters or controls for the Room Mode via checking the desired boxes. In another example, the system preference function identified in the utility function directory 34, allows the user to define general parameters and parameters directly relating to each of the communication modalities. With reference to FIG. 4, clicking on the ‘preference link’ opens a ‘Preferences’ box, which can access a plurality of individual windows or boxes directly related to a particular topic. For example, a ‘General’ link allows the user to define how the user is presented on the system (for example, login invisible), and further allows for the defining of interface features of the communication system (for example, showing a picture in picture window, automatic display of video in all chat rooms or video thumbnail in public listings).

In addition to accessing control operators from the function directory 30, the control operators can be accessed when the communication modalities are opened. For instance, with reference to FIG. 5, the preferences option can be accessed via clicking on the ‘i’ icon 3 8 on the control panel 40 in the video conferencing function, which accesses the ‘Preference’ box and associated windows (shown in FIG. 4). As illustrated in FIG. 4, the preference option allows the user to set audio control related operators for all of the communication modalities, including chat and video. Further, with reference to FIG. 5, operators associated with parameters defining relationships with other users can be accessed via the chat interface, video conferencing interface and the user list. The operators associated with users are directed to the manner in which to treat the identified user, and the messages associated with that user. For example, identified users can be silenced or banned.

As stated above, preferred embodiments of the present invention allow the user to define control parameters which affect the operation of the communication modalities. With respect to specific communication modalities, in preferred embodiments, the user can define functions that can optimize, for the user, the use of the user's equipment, and allow the user to control load on the equipment and timing of the delivery of transmissions. In particular, in preferred embodiments, the user is allowed to define the audio transmission rate at which to receive audio transmissions, restrict receipt of transmission for some modalities, such as, e-mail and v-mail, and prioritize or time the receipt of certain communications. For example, with reference to FIG. 4, in the ‘Audio’ control operator, the user can determine the ‘maximum playback codec rate allowed’. Thus, a user can define a lower audio rate of transmission than what the user's equipment is capable of receiving. In this manner, the user can reduce burden on the user's equipment, thereby allowing the user to utilize other functions more effectively as the resources of the user's equipment will be more effectively managed. Further, users can set a low grade audio setting, such as a setting compatible with dial up bandwidth, to allow the user to hear as much of the users participating in the conference as possible. Further still, in the ‘Chat’ function, a user is allowed to define a ‘chat room buffer memory’, wherein the buffer allows for the storage of audio transmissions that the user desires to hear, but at a later time, or to temporarily store incoming transmissions to allow for an orderly or systematic broadcasting of the transmission. For example, broadcasting in the order of received transmissions. The buffer operator allows a user more effective participation in a multi-user communication in a chat room, wherein both text and audio are present. In this regard, a user that desires to maintain audio communication with one user, but still desires to hear what another user is saying, can store the second user's transmission and listen to it at a user defined time. In this regard, the user is able to effectively have a teleconferencing type session, but manage the burden on the receiving equipment and the receipt of information without sacrificing the quality of the communication by losing information, that is, comments or thoughts from one of the participants.

As stated above, in preferred embodiments, the communication system bundles the communication modalities into one application and is configured to allow the operation of a plurality of communication modalities simultaneously, by a single user, without requiring the user to exit any modality prior to participating in another modality. Thus, for example, a user can be engaged in a chat room, and utilize the video conferencing modality with a specific user from the chat room, or a completely different user not engaged in the chat room. Communications among the users on various modalities are not viewable by other users in a different modality. Thus, in the example described above, the users in the chat room would not be privy to, or realize that a conversation were occurring via video conferencing with one of the users in the chat room and a third party.

To access other modalities, a user need only open the desired communication modality. To communicate with a ‘friend’ or another user on a user list, for example, in the chat room, the user can click and drag a user's name to the new communication modality and transmit a communication to that chosen user. FIG. 5 illustrates an example of multiple use of communication modalities in accordance with preferred embodiments of the invention.

As shown in FIG. 5, the user is participating in a video conferencing session 42, a chat room 44 and video mail 46. With regard to the video conferencing session 42, a set of thumbnail icons 48 previews users currently on-line and available for video conferencing. To create a video conferencing session with one of the persons in the icons, the user clicks on the icon and drags it into the video conferencing box.

The video conferencing box includes picture-in-picture technology, wherein the large window displays the person with whom the user is speaking and the picture-in-picture box is the user. Further, the picture-in-picture box can be used to play a video clip that the user desires to view while simultaneously maintaining real-time communication with the person in the large window via video conferencing. It is to be understood that the user could also choose to display themselves in the large window or replay the video clip in the large window and use the picture-in-picture box for the video conferencing transmission.

In addition to the video conferencing session, the user has opened a chat room 44 and is participating in a conversation with four or five other people. As illustrated, the user ‘Sue’ has sent audio transmission as evidenced by the telephone icon next to her name. In preferred embodiments, the audio will be played in the order transmitted by the participants, if the user has set a control parameter for automatic audio in chat (see FIG. 4). If more than one user is sending audio, the audio will be played in the order received. If the user desires to postpone hearing audio from a particular user because they are focused on a conversation with another user, the user can prioritize the receipt of transmission of a particular speaker and ‘buffer’ other speakers by clicking on the desired speaker's name. Further, the user can participate in both audio and text by depressing a “Talk” button at the bottom of the pull-down listing of current users in the chat room. In preferred embodiments, a voice activation system or VOX is also utilized for the transmission of audio to multiple recipients in the chat room.

As it may become difficult to continuously depress a speaker's name, the user can choose to have a private conversation with a listed user. For example, if the user desires to speak with ‘Jason’, the user clicks on Jason's name and drags it into the tab bar 50, wherein the user can now forward ‘Jason’ audio, text or video mail. It is to be understood that the private conversation can occur while the user is still in the chat room, although the audio in the chat room will most likely be buffered to reduce ‘chatter’ and to assist in controlling the quality of the user's private conversation.

In addition to the video conferencing session and the chat room session, the user has opened video mail 46. The user can review video mail, or record and send video mail. To review the video mail, the user can highlight the desired message to review and utilize the playback button on the control panel 40, or the user can right click on the desired message. Right clicking on a message causes a drop down menu to open, wherein the menu lists possible function options including, but not limited to, reply, forward, delete, rename subject, profile (lists the video mail information about the message, for example, length, size, frames/minute and audio encoding), record new, and manage clips. In addition, the profile option allows a user to report abuse to the administrative manager if the sender of the video mail is forwarding threatening or otherwise inappropriate messages. This abuse option allows users to effectively control specific abuse instances which are directed at the user. In this manner, the abusive user need not be globally banned, but can be restricted via the administrative manager (discussed below) with respect to this particular user.

Upon request to review the video mail, the video mail message opens up in the video conferencing window box. To record a message, the user clicks on the record button and records a message. To forward the message, the user can click on the send/forward button, or utilize the ‘forward’ link in the drop-down menu.

As illustrated in FIG. 5, use of the communication system allows users access to a multi-interactive, multimedia technology environment, wherein the user can control incoming information and transmissions. The cross accessibility of the multiple forms of communication increase a user's ability to more effectively and enjoyably communicate to others. Further, the ease of access to multiple communication modalities without the requirement to exit one communication modality to access another decreases the cost of communication with respect to the amount of time that must be utilized to transmit a message via varying modalities.

Prior to utilizing, or participating in the communication system 20, users must register or establish an account with the communication system. To establish an account with the communication system 20, the user accesses the communication system via an interface, such as a Web page. The interface includes a form with a ‘Set-up Account’ button, or any other interface that may be suitable. Upon activation of the ‘Set-up Account’ button, a set-up page is transmitted to the user, wherein the user enters identifying information, including, but not limited to, a unique identification and a password. The information is entered via input boxes or via response to questions presented by the communication system 20. Once the user is satisfied that the input information is accurate, the user submits the information to the system via a ‘Submit’ button. The submitted information is then validated and written into the storage database 26. In some preferred embodiments, a user must pay to access the communication system, wherein payment methods include any of the payment methods currently used or by any other suitable means, including, but not limited to, both on-line and off-line payment methods.

Once the user has established or opened an account, the user can access the function directory and establish a ‘friend’ list, wherein the ‘friend’ list allows a user to monitor the availability status of particular people. In this manner, the user automatically knows whether one of the listed ‘friends’ is available. In addition to establishing a ‘friend’ list, in some preferred embodiments, a personal profile can be created, wherein the user can include, but is not limited to, information regarding hobbies, travel experiences, favorite foods, favorite places, music preferences, and likes and dislikes. Further, the user can begin to set parameters for the various communications modalities and the user interface as discussed above, Additionally, if desired, users can create a public listing, wherein their personal profile is listed. In addition to the personal profile, the user can create a short video clip and include photographs of themselves for display. The public listing allows other users the opportunity to review additional information about the people with whom they are communicating. The information in the public listing is coupled to the user's name as listed in a user on-line list or in the images of users available for video conferencing, and opens as an option in the control operator list when the user's name or image is right clicked.

To control the overall management of the integrated communication system 20 and the accounts established therein, the communication system 20 includes an administrative manager 28. The administrative manager 28 manages the accounts and users of the communication system 20 via an account management tool. The account management tool allows the administrative manager to review and control all aspects of an account, including, but not limited to, the status of the account, history of payments, use of the account, reported abuses associated with the account, and any other function that relates to an account. If an account has not been used for a given period of time or is not current with subscription dues, the administrative manager 28 can deactivate the account or suspend the account.

Further, the administrative manager 28 monitors a user associated with the account, including reports of abusive behavior for a given user, content in the user's public listing or other pertinent issues. If a user is engaged in abusive behavior, or has otherwise violated a rule, the administrative manager 28 can remove the user from the system for abusive behavior, or suspend user privileges for a given period of time. Further, the administrative manager can place identifying information about the user, including name, password, payment information and the like, in a watch database so that the user cannot establish a new account if the user is banned from the communication system 20.

In addition to the accounts and users, the administrative manager 28 manages the overall communication system 20, including the adding or removal of chat rooms, the permissions granted to users in a chat room, the adding of other administrators and the like. To ensure efficient operation of the communication system 20, the administrative manager 28 has full access to all areas of the system, including, user login information, private chat room, and the like. In this manner, the communication system 20 can maintain an enjoyable environment for all users and prevent disruptive or abusive communications among users.

In operation, a user registers with the communication system. Once the user has registered with the communication system, the communication system is downloaded and installed onto the user computer 14. The communication system can remain in an open state on the user computer via an icon, wherein clicking on the icon places the communication system in the top most window on the user's computer.

After the communication system is loaded onto the user's computer, the user logs into the system, and if desired, predefines various parameters for the user interface and the communication modalities. If the user does not define any parameters, the communication system automatically creates default settings for the control parameters, wherein the user computer 14 transmits appropriate information directed to equipment limitations to the provider server 12 via well known communication protocols.

Once the user has logged into the system, the user accesses a user interface, wherein the communication modalities are listed. To open a particular communication modality, the user clicks on the icon or link representing the modality. Once the communication modality is opened, the user can commence participation in the system. During the session, the user can open any or all of the available communication modalities, and simultaneously participate in communications via the various modalities.

It is to be understood that embodiments of the above described communication system can be used in any type of application. For example, in one preferred embodiment, a dating service can be established utilizing the system. In this regard, users can communicate via a plurality of modalities with prospective partners or dates. Indeed, communicating via text is greatly different than audio communication or visual communication. As these varying degrees of communication modalities enhance one's ability to assess another person, the dating service utilizing the communication system allows for better determination of interest in a potential date prior to ever meeting face to face or expending time or money on a date.

In one preferred embodiment, a dating service utilizing the communication system allows users to submit a requested profile, wherein the ‘seeking’ user creates the profile of the person that they would like to meet. In this embodiment, upon submission of the requesting profile, the communication system 20 searches the database 26 containing the user profiles created by each user via a search engine. Matches to the requesting profile are listed in a list result, wherein, if provided, a picture of the matched user is displayed. Upon clicking upon the picture, the seeking user can review the matched user's profile and other information provided, such as, the video clip.

The dating service is not limited in the types of services it can offer to users. Indeed, the system provides users anonymity by restricting access to true e-mail addresses, wherein a user can reply to an e-mail via a link provided in the forwarded e-mail. It is to be understood that all of the features of the communication system 20 can be easily added and applied to other applications, such as the dating service. Further, it is to be understood that other features relevant to the particular application can be added to the communication system 20 without affecting the basic operation of the communication system 20, but instead enhancing the particular application.

Although the foregoing described the invention with preferred embodiments, this is not intended to limit the invention. Indeed, in other preferred embodiments, the communicatin system is implemented in conjunction with ‘white board’ capabilities. In this regard, groups of engineers or physicists, for example, can simultaneously discuss a problem from their respective locations, wherein each participating party has the ability to add comments, corrections and the like to the ‘white board’ for the group to review. This type of exchange allows the facilitation of the solution to a problem without requiring all parties to travel to the same location. In this regard, persons that might not otherwise work together have the opportunity to effectively work together.

In still other preferred embodiment, the communication system is coupled to a third party network system. For example, in one preferred embodiment, the communication system operates in conjunction with wireless applications, such as cellular telephones, wherein the communication system can communicate with the cellular telephone irregardless of the make and model of the telephone, or the particular company operating the telephone system. Currently, different cellular telephone companies are incompatible with each other and thus, text messages, for example, from one company cannot be forwarded to user on a different system. Embodiments of the present invention allow for the forwarding of text messages from the communication system to any user utilizing any cellular telephone. Further still, in some embodiments of the present invention, text messages can be forwarded to Palm Pilots and personal digital assistants (“PDAs”). To operate with third party systems, the communication manager includes an operator identifying the third party system in the function directory. Upon selection of the third party operator, the communication system enables the software and hardware for communicating with the outside system in accordance with standard operating procedures and protocols. As seen from above, the foregoing is intended to cover all modifications and alternative constructions falling within the spirit and scope of the disclosure and the embodiments, as described, and as expressed in the appended claims, wherein no portion of the disclosure is intended, expressly or implicitly, to be dedicated to the public domain if not set forth in the claims.

What is claimed is:

1. A communication system on a computer network having a provider computer and a user computer, wherein the provider computer and the user computer are in communication therebetween, the system comprising:
a communication manager comprising a transmission rate converter;
a communication means comprising a plurality of communication modalities, wherein the communication modalities are simultaneously accessible to the user computer via the communication manager; and
means for presenting to the user computer the plurality of communication modalities

2. A communication system as claimed in claim 1, further comprising a set of control factors, wherein a user of the user computer defines at least one factor in the set of control factors to create defined user criteria, wherein the defined user criteria represents acceptable parameters of the user computer for the receipt of communication transmissions.

3. A communication system as claimed 2, wherein the communication manager is configured to transmit communications to the user computer in accordance with the defined user criteria.

4. A communication system as claimed in claim 1, further comprising means for receiving a profile characteristic set from the user computer, wherein the profile characteristic set represents data regarding a first user desirous of utilizing the communication system, and means for receiving a requested profile characteristic set from the user computer, wherein the requested profile characteristic set represents data regarding a second user that the first user is desirous of exchanging transmissions.

5. A communication system as claimed in claim 1, further comprising a processor, wherein the processor is configured to compare the profile characteristic set to the requested profile characteristic set and determine whether the profile characteristic matches the requested profile characteristic set within a predefined matching tolerance.

6. A communication system as claimed in claim 1, wherein the plurality of communication modalities consist of any of the following modalities: electronic mail, video mail, video conference, file transfer means and chat.

7. A communication system as claimed in claim 1, wherein the communication manager further comprises a function directory having a plurality of functions and a set of control operators, wherein the control operators define use parameters for the plurality of functions

8. A communication system as claimed in claim 1, wherein the transmission rate converter is configured to identify an incoming transmission rate from a first user computer and a receiving transmission rate of a second user computer, and convert the incoming transmission rate to the receiving transmission rate.

9. A communication system as claimed in claim 1, further comprising a user buffer mechanism.

10. A communication system as claimed in claim 1, wherein the plurality of communication modalities comprises a first communication modality having an open state and a closed state and a second communication modality having an open state and a closed state, wherein a first user computer can transmit data to a second user computer via the first communication modality in the open state and transmit data to a third user computer via the second communication modality in the open state, substantially simultaneously.

11. A communicator apparatus for use on a computer network having a provider computer and a user computer, wherein the provider computer and the user computer are in communication therebetween, the communicator comprising:
a communication manager having a user interface, wherein the communication manager comprises a function directory having a plurality of functions and a set of control operators, wherein the control operators define use parameters for the plurality of functions;
a plurality of communication modalities, wherein the communication modalities are coupled to the communication manager, and wherein the communication modalities are accessible through the user interface; and
a storage database, wherein the storage database stores the use parameters defined by the control operators.

12. A communicator as claimed in claim 11, further comprising a transmission rate converter.

13. A communicator as claimed in claim 11, wherein the plurality of communication modalities comprises a first communication modality having an open state and a closed state and a second communication modality having an open state and a closed state, wherein a first user computer can transmit data to a second user computer via the first communication modality in the open state and transmit data to a third user computer via the second communication modality in the open state, substantially simultaneously.

14. A communication system as claimed in claim 11, wherein the plurality of communication modalities consist of any of the following modalities: electronic mail, video mail, video conference, file transfer means and chat.

15. A communication system as claimed in claim 11, further comprising a user buffer mechanism.

16. A method for transmitting communications on a communication system on a computer network having a provider computer and a user computer, wherein the provider computer and the user computer are in communication therebetween, the method comprising:
accessing a user interface, wherein the user interface comprises a function directory having a plurality of functions and a set of control operators, wherein the control operators define use parameters for the plurality of functions, and wherein the plurality of functions defines a plurality of communication modalities available on the communication system, the plurality of communication modalities comprising a first communication modality having an open state and a second communication modality having an open state;
accessing the first communication modality in the open state;
accessing the second communication modality in the open state;
transmitting data via the first communication modality; and
transmitting data via the second communication modality, wherein the first communication modality and the second communication modality reside in the open state.
